(19) United States
(12) Patent Application Publication
(10) Pub. No.: US 2013/0256072 A1
(43) Pub. Date: Oct. 3, 2013

(54) Luggage Having A Folded Bed

(71) Applicant: Modrek Farhat, Richmond Hill (CA)

(72) Inventor: Modrek Farhat, Richmond Hill (CA)

(21) Appl. No.: 13/437,582

(22) Filed: Apr. 2, 2012

(51) Int. Cl. A47C 17/82; A47C 17/70; A01G 9/02

(52) U.S. Cl. 190/2; 190/1; 5/112

(57) ABSTRACT

A suitcase configured to transform to a bed is provided. It includes a frame with a hinge. The frame is secured to a first portion and a second portion. The second portion is pivotally connected to a first portion about the hinge. The first portion and the second portion respectively include a first inner face and a second inner face. The first inner face includes a first mattress and the second inner face includes a second mattress. At least one of the first portion and the second portion include a fastener to releasably secure the second portion to the first portion. When the first portion and the second portion are in an open configuration, the first mattress and the second mattress form the bed.

### TECHNICAL FIELD

The following relates generally to luggage having a folding bed.

### BACKGROUND

Foldable furniture including foldable tables, chairs, and beds, are widely used since they are portable relative to non-folding furniture and are compact when folded. Folding furniture is convenient when the use for furniture is temporary. Folding furniture is particularly useful when transportation and storage of conventional furniture is impracticable.

Due to its wide and varying applicability, folding furniture is common in residential, commercial and military applications. For example, folding chairs are used to accommodate dinner guests. Folding beds are used by military personnel while deployed away from barracks. Hotels use folding chairs to accommodate an unusually large number of guests at a dinner gathering.

Folding furniture is also used by travelers. In particular, folding furniture is advantageous for travelers who are waiting or resting in a location where furniture is unavailable. For example, rucksacks comprising a frame which may be folded to form a stool are available for campers.

### BRIEF DESCRIPTION OF THE DRAWINGS

Embodiments will now be described by way of example only with reference to the appended drawings wherein:

FIG. 1 is a front perspective view of an example suitcase bed in the folded position;

FIG. 2 is a rear perspective view of the example suitcase bed of FIG. 1 in the folded position;

FIG. 3 is a front view of the example suitcase bed of FIG. 1 in the folded position;

FIG. 4 is a side view of the example suitcase bed of FIG. 1 in the folded position;

FIG. 5 is a bottom view of the example suitcase bed of FIG. 1 in the folded position;

FIG. 6 is a front perspective view of the example suitcase bed of FIG. 1 in the folded position showing an opening to a storage compartment;

FIG. 7 is a front perspective view of the example suitcase bed of FIG. 1 in the folded position from a different vantage point;

FIG. 8 is a perspective side view of the example suitcase bed of FIG. 1 in a partially unfolded position;

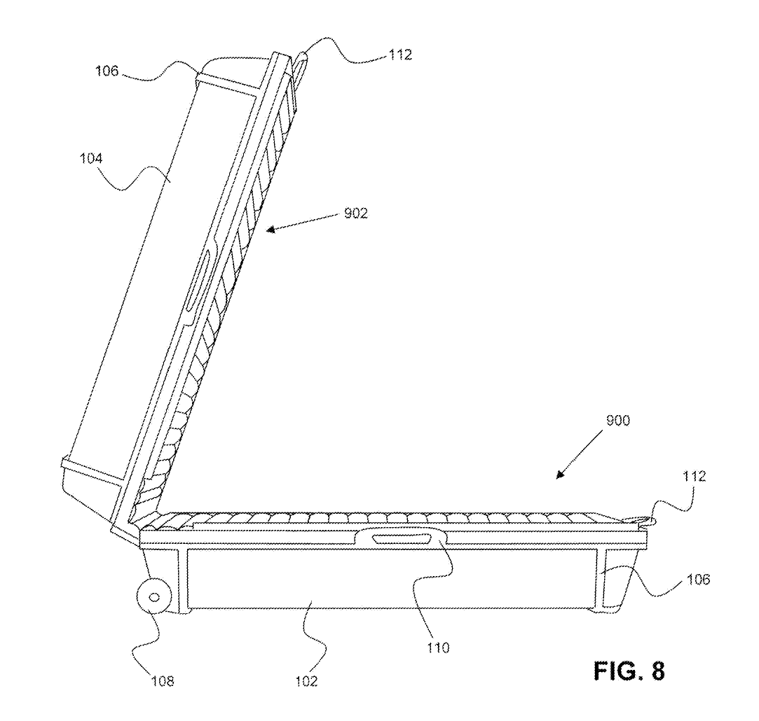

FIG. 9 is a plan view of the example suitcase bed of FIG. 1 in an unfolded position;

FIG. 10 is a plan view of the underside of the example suitcase bed of FIG. 1 in an unfolded position;

FIG. 11 is a perspective side view of the example suitcase bed of FIG. 1 in the unfolded position;

FIG. 12 is a perspective view of the example suitcase bed of FIG. 1 in the unfolded position with a partially deployed canopy;

FIG. 13 is a perspective view of the example suitcase bed of FIG. 1 in the unfolded position with a fully deployed canopy;

FIG. 14 is a block diagram of an example suitcase bed electrical system in accordance with the present invention;

FIG. 15 is a perspective side view of an example folding potting bed in the unfolded position;

FIG. 16 is a perspective side view of the example folding potting bed of FIG. 15 with a partially deployed canopy;

FIG. 17 is a perspective side view of the example folding potting bed of FIG. 15 with a fully deployed canopy;

FIG. 18 is a perspective side view of the example folding potting bed of FIG. 15 in a partially folded position;

FIG. 19 is a perspective side view of an example folding potting bed of FIG. 15 in a partially unfolded position and with a lid to cover the first portion;

FIG. 20 is a side view of an example folding potting bed in an unfolded position showing roots growing through perforations into the underlying soil;

FIG. 21 is a flow diagram showing example steps of closing the folding potting bed of FIG. 20;

FIG. 22 is a side view of an example folding potting bed of FIG. 20 in a folded position;

FIG. 23 is a side view of an example collapsible bed;

FIG. 24 is a side view of the collapsible bed of FIG. 23 having a foldable seat;

FIG. 25 is a diagram of the collapsible bed of FIG. 23 being unfolded;

FIG. 26 is a side view of the example collapsible bed of FIG. 23 in the deployed position;

FIG. 27 is an side view of the example collapsible bed of FIG. 23 with a canopy; and

FIG. 28 is an end view of the example collapsible bed of FIG. 23 with a canopy.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practised without these specific details. In other instances, well-known methods, procedures and components have not been described in detail so as not to obscure the example embodiments described herein.

Also, the description is not to be considered as limiting the scope of the example embodiments described herein. This application is used as an example and the principles outlined herein are applicable to other pieces folding furniture and other types of luggage.

Although folding furniture is commonplace and its uses and configurations are many, folding furniture is typically cumbersome for travelers, requires significant space to carry and offers little privacy when deployed in public locations.

In an example, there is provided a folding bed in a transportable container, for example, an item of luggage. In the example embodiment illustrated by the figures, the item of luggage is a suitcase. In particular, there is provided a transportable container which unfolds to form a sleeping surface. To provide privacy to a person resting on the sleeping surface, the folding bed further comprises a canopy which may be deployed over the suitcase bed to provide the resting person a shelter. This can be used, for example, for in military environments, medical treatment environments, and in other travelling scenarios.

In another example, there is provided a moveable potting bed formed in an item of luggage, for example, a transportable suitcase. The potting bed comprises a first portion and a second portion. Soil is provided in a portion of the suitcase. The potting bed may comprise a canopy which may be deployed to at least partially shelter any potted plants from the environment. In one embodiment, the canopy provides a greenhouse effect to maintain a particular temperature and humidity of the potted plants therein while enabling at least some light to enter the potting chamber. To transport the potted plants, the canopy may be folded away and the second portion may be secured to the first portion to form a rigid frame about the potted plants.

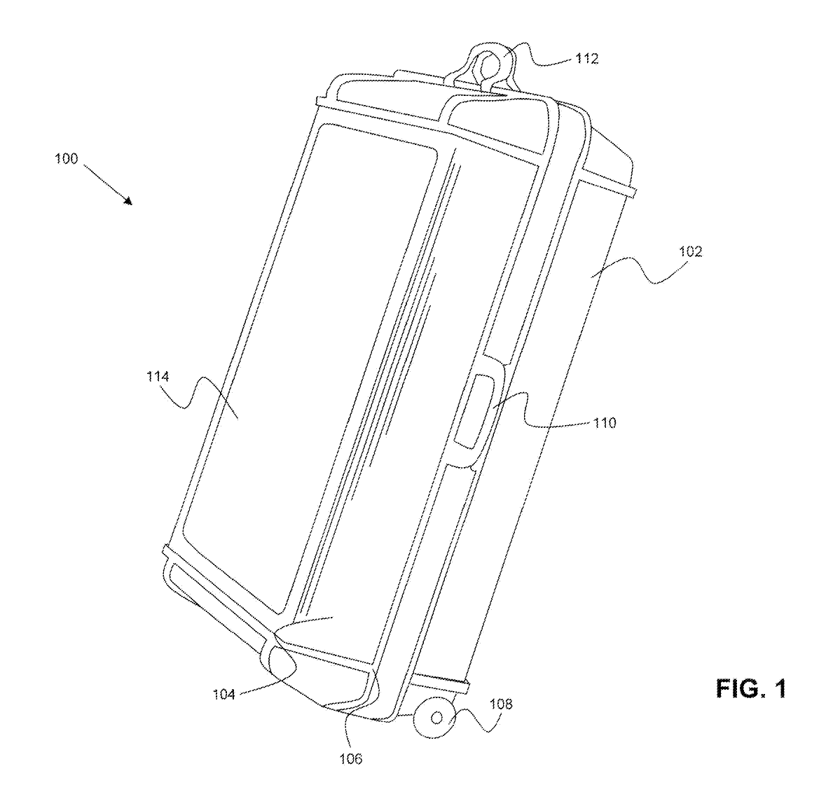

Turning to FIG. 1, a suitcase bed 100 is shown. The suitcase bed 100 comprises a frame 106. The frame 106 supports a second portion 104 and a first portion 102. In one embodiment, the frame 106 supports a pair of wheels 108 (second wheel not shown) to facilitate transportation of the suitcase bed 100. In an embodiment, the frame 106 comprises a side handle 110 and an end handle 112 to enable a person to grip and/or carry the suitcase bed 100. The side handle 110 and/or the end handle 112 may be extensible to enable a person to pull the suitcase bed 100 on its wheels 108. The suitcase bed 100 includes an opening and closing top cover 114 which isolates a second storage compartment (not shown) which may be used to store articles (e.g. clothing, books, electronic, food, medical supplies, equipment, etc.). In an example embodiment, the second portion 104 and the first portion 102 are integral with the frame 106. In another example embodiment, the second portion 104 and the first portion 102 are detachable from the frame 106. The second portion 102 and first portion 104 may be of any height, length, and thickness that enable the suitcase bed 100 to be deployed and to support a person lying thereon.

The frame 106 is a rigid component of the suitcase bed 100. In an example embodiment, the frame 106 is formed from moulded plastic. In another example embodiment, it is formed from other materials, for example, a metal, a composite, or wood. Preferably, the frame 106 is sufficiently tough to absorb impact and compressive stresses that may be dealt to the suitcase bed 100 while it is being transported, for example, by luggage handlers at an airport. The frame 106 is also preferably formed from a light material to minimize the weight of the suitcase bed 100. The frame 106 is preferably formed from a material that has at least some weather resistance, for example, ABS or PVC plastic. In an example embodiment, the frame 106 is made of aluminum or an aluminum alloy. In another example embodiment, the frame 106 is made of a combination of materials.

The second portion 104 and first portion 102 of the suitcase bed 100 may be formed from a metal, a composite, or a plastic. For example, the second portion 104 and the first portion 102 are formed from ABS. In another example embodiment, the second portion 104 and first portion 102 are formed from metal, for example, an aluminum alloy. In an example embodiment, the top cover 114 on the second portion 104 is formed from a flexible material, for example, a polymer weave such as nylon. In an example embodiment, the top cover 114 is formed from a solid material, for example, ABS. The top cover 114 is attached to the second portion 104 via, for example, a zipper, hook and loop fastener, a hinge, buttons, etc. In another example embodiment, the top cover 114 may be partially integral with the second portion 104 of the suitcase bed 100.

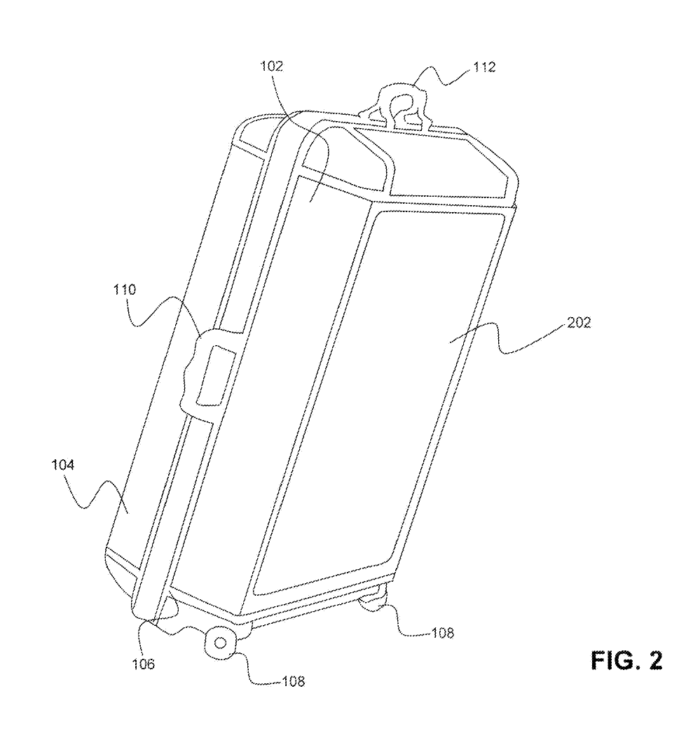

Referring now to FIG. 2, the rear side of the suitcase bed 100 is shown. The first portion 102 optionally comprises a rear cover 202 which isolates a first storage compartment (not shown) which may also be used to store articles, for example, luggage. As can be appreciated from FIG. 2, the end handle 112 may be used in combination with the wheels 108 to pull or push the suitcase bed 100. Side handle 110 may also be used to carry the suitcase bed 100.

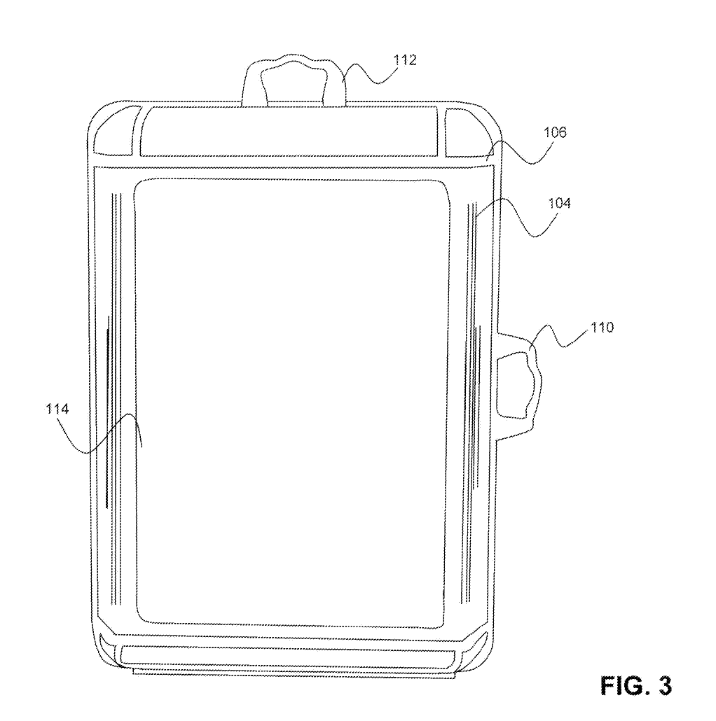

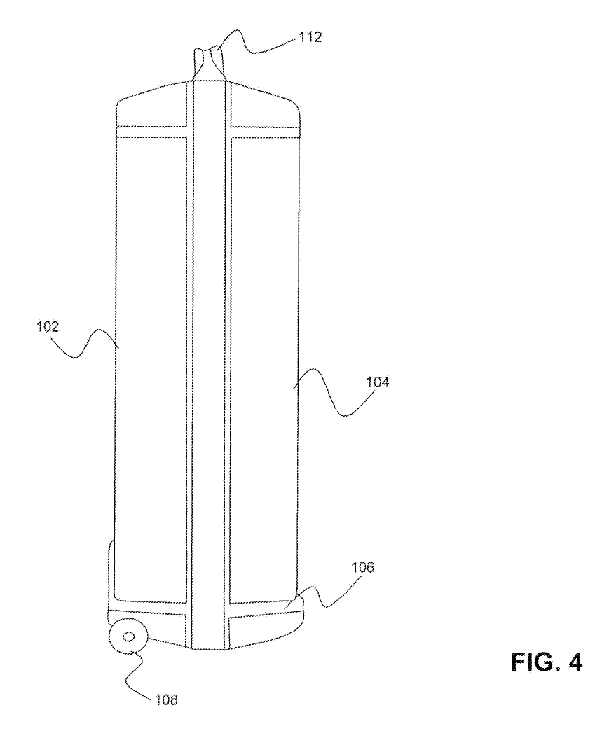

Turning to FIG. 3, the front of the suitcase bed 100 is shown. In an example embodiment, the top cover 114 covers a substantial area of the second portion 104. In an example embodiment, the top cover 114 covers approximately 80% of the surface of the second portion 104 of the suitcase bed 100. Other sizes of covers 114 and 202 can be used. As can be seen from FIG. 3, the frame 106 surrounds the second portion 104. FIG. 4 shows a side view of the suitcase bed 100 and a frame that surrounds both the second portion 104 and the first portion 102 of the suitcase bed 100.

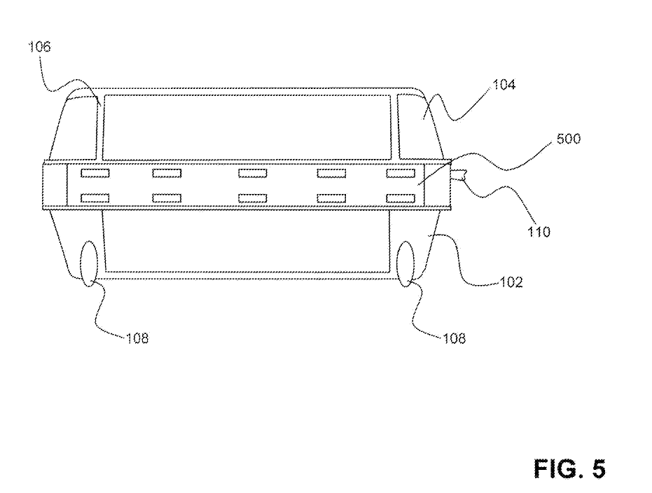

FIG. 5 provides a view of the bottom of the suitcase bed. Similar to FIG. 4, the frame 106 is shown surrounding the second portion 104 and the first portion 102 of the suitcase bed 100. In an example embodiment, the wheels 108 extend slightly behind the rear of the suitcase bed 100 and are fixed to the frame 106 such that when the first portion 102 of the suitcase bed 100 is placed flat on a surface, the wheels 108 do not make contact with that surface. As can be seen in FIG. 5, the suitcase bed 100 comprises a hinge 500. The hinge 500 enables the second portion 104 of the suitcase bed 100 to pivot about the hinge 500 with respect to the first portion 102. The hinge 500 is fixed to the frame 106. In an example embodiment, hinge 500 comprises two halves, a first half being connected to the frame 106 on the second portion 104 and a second half being connected to the frame 106 on the first portion 104. In various example embodiments, the hinge 500 comprises a concealed hinge, a pivot hinge, a barrel hinge, and a piano hinge. In an example embodiment the hinge is a double hinge. Other hinges that enable the second portion 104 to pivot about the hinge 500 with respect to the first portion 102 by at least about 180 degrees can be used. In an example embodiment, the hinge 500 is formed integrally with the frame 106. For example, the hinge 500 is moulded integrally with at least a portion of the frame 106. In other example embodiments, the hinge is fastened, glued, fixed or connected to the frame.

The second portion 104 is removably secured to the first portion 102 on the three sides that are not connected to the hinge 500. For example, the second portion 104 is removably secured to the first portion 1302 via clasps, a hook and loop fastener, a zipper, etc.

In an example embodiment, the frame 106 provides structural support to both the second portion 104 and the first portion 102 of the suitcase bed 100. In an example embodiment, the frame 106 ensures that there are fewer points of contact between a surface upon which the suitcase bed 100 is resting and the suitcase bed 100 itself. In an example embodiment, the frame 106 is provided with feet to further reduce the fraction of the frame 106 that is in contact with the surface upon which the suitcase bed 100 is resting. For example, the feet may comprise small hemispherical protrusions moulded into the frame 106 to hold the frame 106 off a surface. The protrusions may be formed of a gripping material, for example, a rubber, to reduce the likelihood that the suitcase bed 100 slides on a surface.

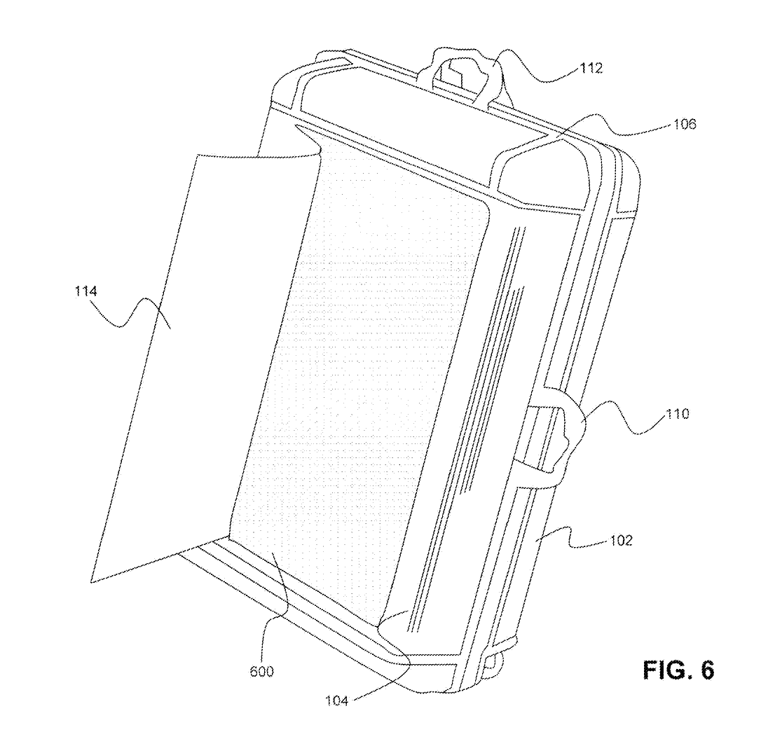

As mentioned above, in an example embodiment, the top cover 114 is at least partially detached from the second portion 104 of the suitcase bed 100 to reveal a second storage compartment 600. The top cover 114, when closed, secures items within the second storage compartment. The second storage compartment 600 may be used to store articles, for example, clothes, books, etc. The second storage compartment 600 is separated from the first storage compartment (not shown), as will be apparent from the following figures. The top cover 114 is formed from a flexible material in the example embodiment of FIG. 6. However, it can be appreciated that in other example embodiments the top cover is formed from a rigid material. Pockets and dividers may be present in the second storage compartment 600. The second portion 104 may also have two or more storage compartments. For example, the second portion 104 comprises a smaller compartment in the top cover 114 to store personal items. It will be appreciated that any number of compartment divisions and restraining mechanisms in the second storage compartment 600 can be used.

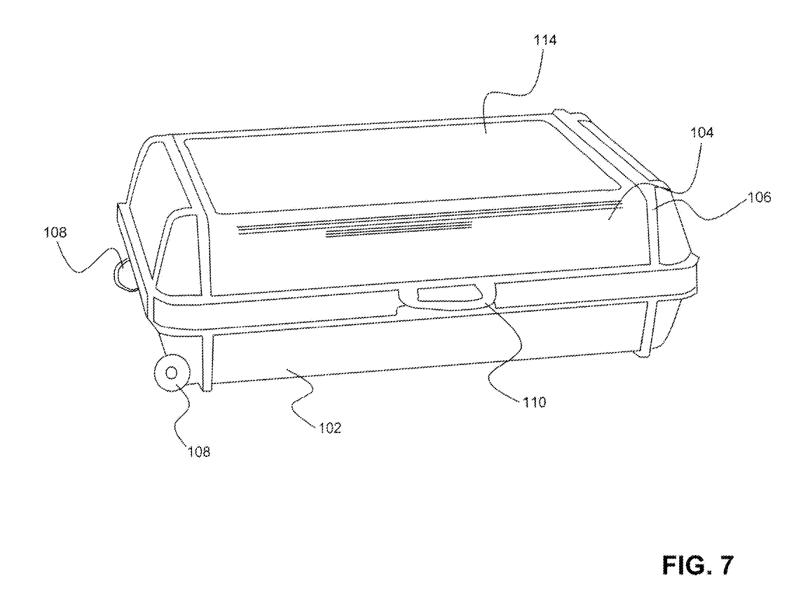

Turning now to FIG. 7, the suitcase bed 100 is shown resting on the first portion 102. The wheels 108 are not in contact with the surface upon which the suitcase bed 100 rests. As was described above, the frame 106 supports the suitcase bed 100 and may comprise protrusions which reduce the surface area of the frame that is in contact with the surface upon which it rests. The pair of wheels 108 is not in contact with the surface upon which the frame rests to reduce rolling while pivoting the second portion 104 with respect to the first portion.

The second portion 104 of the suitcase bed 100 is pivotal about the hinge 500. For example, in one embodiment, the second portion 104 is pivotal with respect to the first portion 102 to about 180 degrees to form a substantially flat surface. The second portion 104 is releasably secured to the first portion 102 by a fastener prior to unfolding the bed. For example, the fastener may be a zipper, a button, a latch, a button snap, a band, a belt, a hook, etc.

To pivot the second portion 104 with respect to the first portion 102, the end handle 112 may be gripped by the user to pivot the second portion about the hinge. Protrusions on the frame 106 may increase the friction between the frame 106 and the surface upon which it rests to reduce sliding of the bottom potion 102. The inner face of the first portion 102 comprises a first mattress 900 and the inner face of the second portion 104 comprises a second mattress 902. The first mattress 900 and second mattress 902 are inward facing and the surface of each of the second mattress 902 and the first mattress 900 defines a bedding surface. The inner portion of the hinge 500 may also comprise a mattress element to bridge any gap between the first mattress 900 and the second mattress 902. The second mattress 902 and the first mattress 900 may be formed of foam, an inflatable mattress, a fabric stuffed mattress or any other material suitable for a bed. The mattress 900, 902 may be perforate or breathable to enable a person on the mattress to lay comfortably in warm conditions.

In an example embodiment, the second mattress 902 and the first mattress 900 are supported by the frame 106 to reduce any compressive forces on the first portion 102 and the second portion 104 of the suitcase bed. In another example embodiment, the second mattress 902 and the first mattress 900 are otherwise completely or partially supported by items within the first and second storage compartments. For example, a user may fill the first and second storage compartments with clothing, which can bear the weight of a user resting on the second mattress 902 or the first mattress 900.

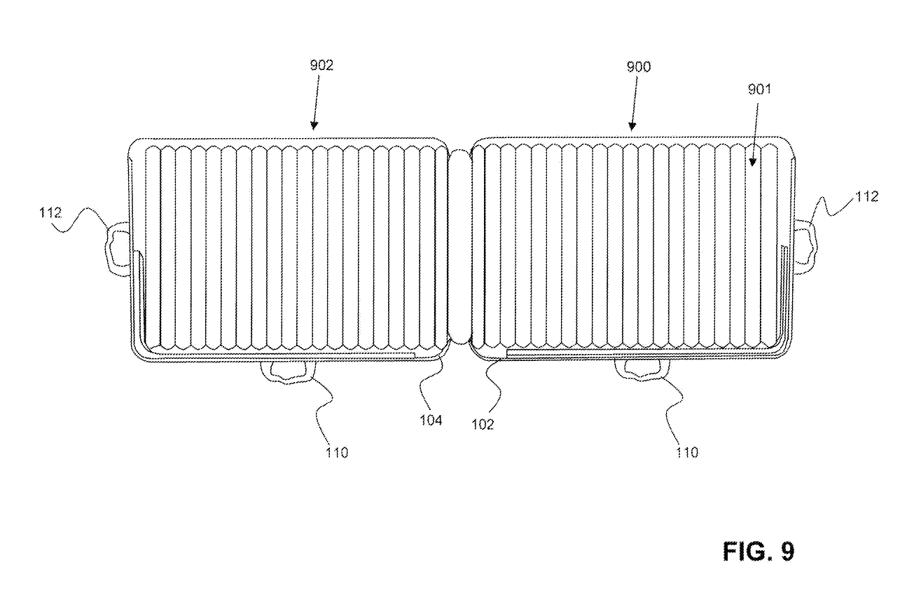

Referring now to FIG. 9, an overhead view of the suitcase bed 100 is shown. The second portion 104 has been unfolded approximately 180 degrees with respect to the first portion 102. The second mattress 902 and the first mattress 900 are substantially aligned, enabling a user to rest flat on the entire mattress portion 901.

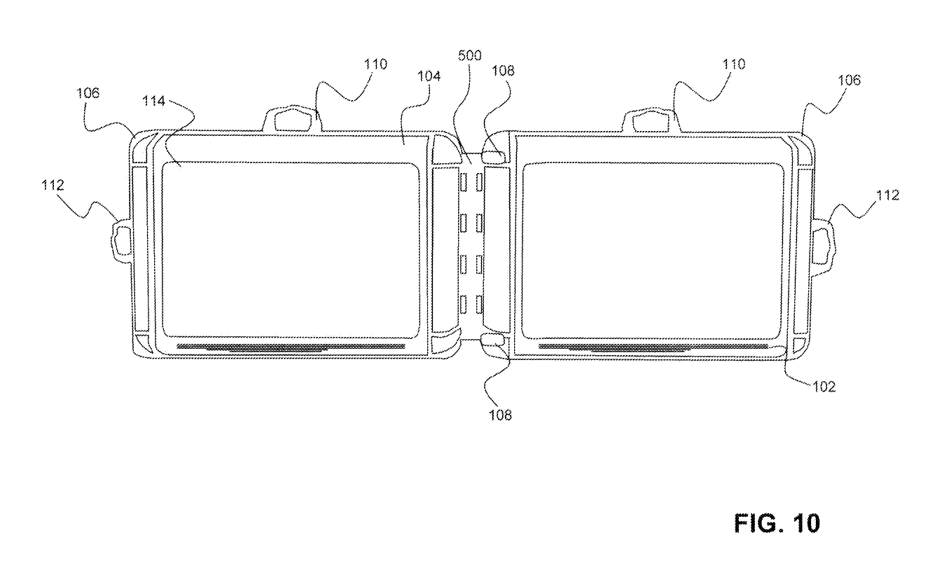

FIG. 10 provides a view of the underside of the suitcase bed 100 in the unfolded position. As can be seen from FIG. 10, the hinge 500 may at least partially support a person lying on the top mattress.

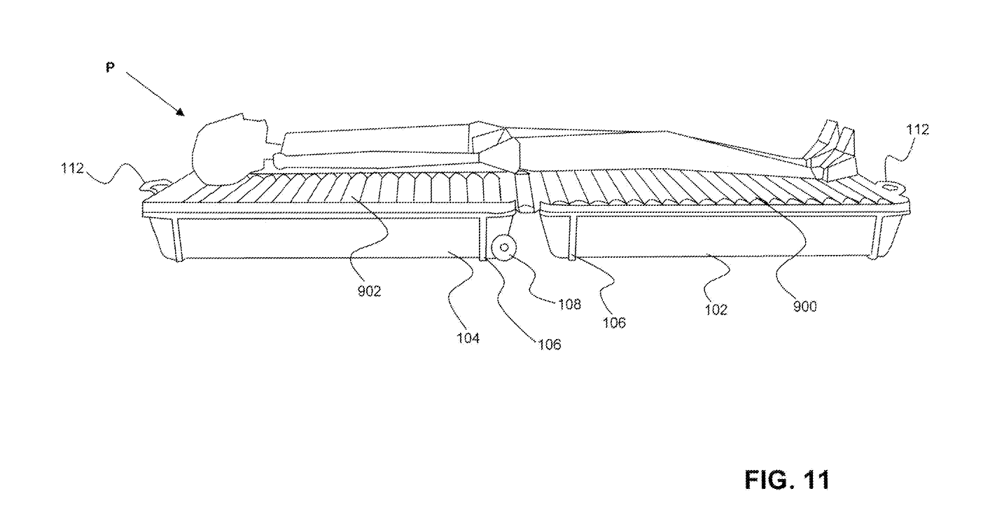

Turning now to FIG. 11, a person P is shown resting on the mattress 901. The mattress 901 is substantially the same length as the person P is tall. While resting on the unfolded bed 100, the person P is better enabled to supervise belongings within the first and second storage compartments of the suitcase bed 100.

In particular, when the person P lies on the mattress 901, as shown in FIG. 11, the covers 114 are facing the ground surface. Therefore, a thief cannot open or close the covers 114 to access the first or second storage compartments without alerting or disturbing the person P. In this way, the suitcase bed 100 provides security for the person's belongings.

Although the person P may be comfortable resting on the mattress 901, the person P may lack privacy. For example, if the person P wishes to deploy the suitcase bed in an airport, the person P may be watched by observers. To provide person P with more privacy, in an example embodiment, a canopy covering the person P is erected.

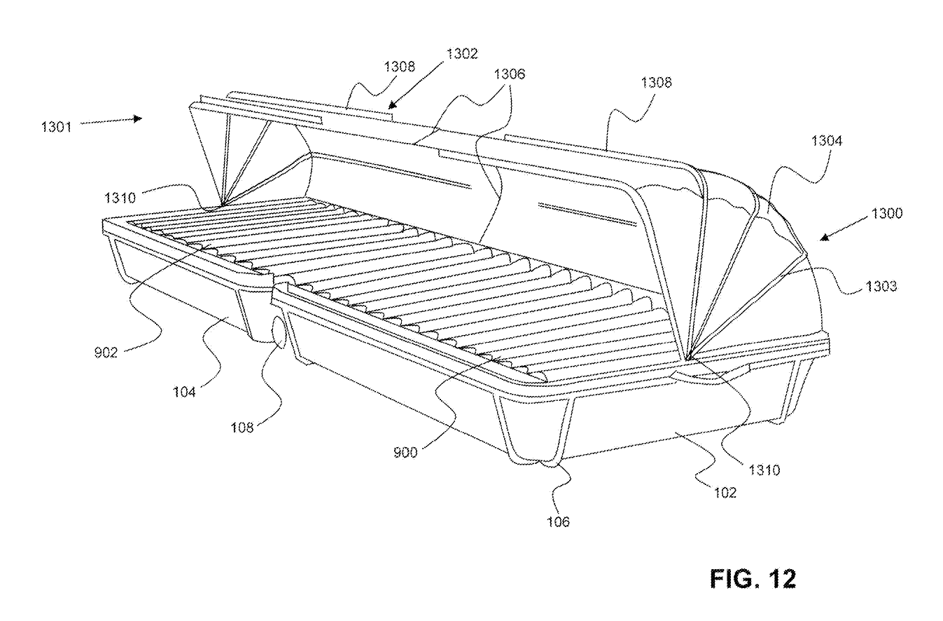

As can be seen in the example embodiment of FIG. 12, the canopy 1301 is a folding canopy formed of a flexible cover material 1304 supported by a rigid structure. The canopy 1301 comprises a first canopy portion 1300 and a second canopy portion 1302 which are connected at a hinge seam 1306. The two halves of the canopy 1301 enable the canopy 1301 to fold. The second portion 104 pivots with respect to the first portion 102 about the hinge 500. The canopy 1301 may be stored in the ends and sides of the second portion 104 and the first portion 102 before it is unfolded.

In the example embodiment of FIG. 12, the rigid structure supporting the flexible cover material 1304 comprises a plurality of end supports 1303 which are connected to longitudinal supports 1308. In an example embodiment, the end supports 1303 are rotatably coupled to a pivot 1310 at each end of the canopy 1301. A person P may grip the edge of the canopy 1301 and move the canopy in an approximately arcuate path about the axis of the pivots to open and close the canopy 1301. As the canopy 1301 is closed, the flexible canopy material 1304 becomes more taught and is supported by the longitudinal supports 1308 and the end supports 1303.

In an example embodiment, the second canopy portion 1302 is connectable to the first canopy portion 1300. For example, a zipper, hook and loop, button snaps, etc. may be used to connect the second canopy portion 1302 with the first canopy portion 1300. With the second canopy portion 1302 connected to the first canopy portion 1300, a person P on the mattress 901 need only close either the second canopy portion 1302 or the first canopy portion 1300 to close the entire canopy 1301. Optionally, the longitudinal supports 1308 on the first canopy portion 1300 may connect with the longitudinal supports 1308 on the second canopy portion 1302.

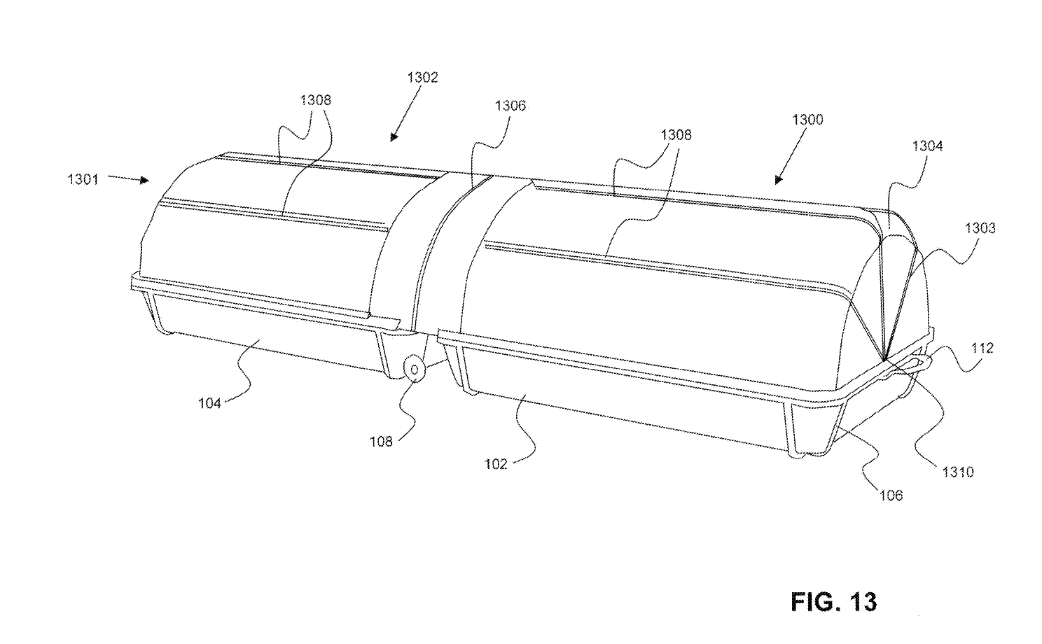

Turning now to FIG. 13, a suitcase bed 100 comprising a canopy 1301 that has been completely closed is provided. In this example embodiment, the cover material 1304 is stretched taught over the longitudinal supports 1308 and the end supports 1303. In an example embodiment, air passages are provided for a person P within the canopy 1301 to breathe easily. The cover material 1304 may be formed from a fabric, for example, a polymeric fabric, a waterproof fabric, a breathable fabric, etc. The cover material may also be formed from a flexible polymer.

The canopy 1301 may be secured in the closed position from the inside. When the person P on the suitcase bed 100 desires to exit the canopy, the person P could release and fold the canopy 1301 as is described below. The canopy 1301 may completely enclose a person P on the suitcase bed 100, as can be seen from FIG. 13. The canopy 1301, when secured in the closed position, remains taught and is supported away from the body of the person P by the longitudinal supports 1308 and the end supports 1303.

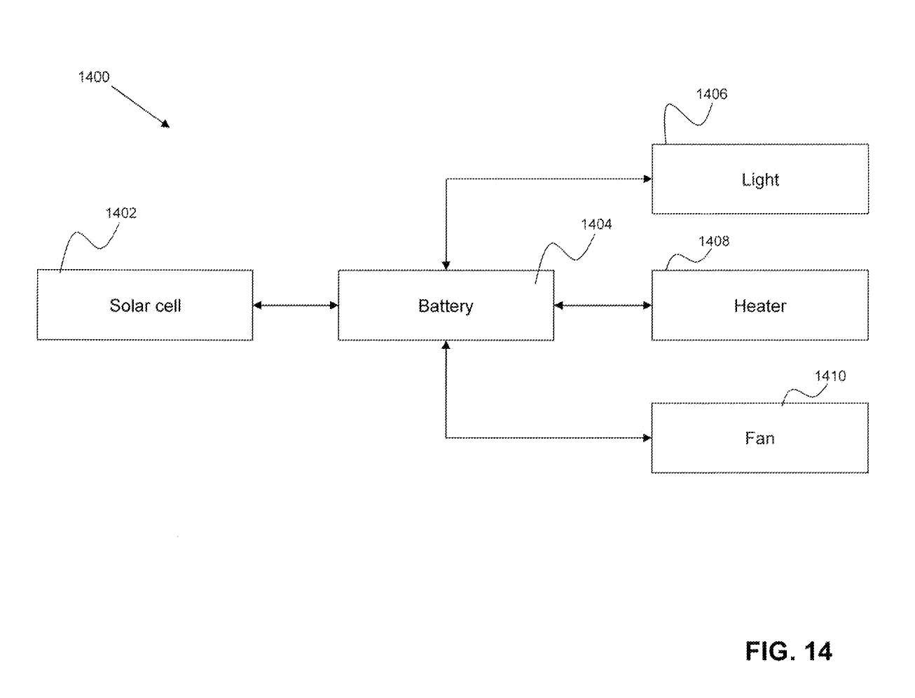

The canopy 1301, in some example embodiments, comprises an electrical system. The electrical system comprises a solar panel which may power a battery within the suitcase bed 100. Referring to the example embodiment of FIG. 14, the battery pack is in communication with a light 1406, a heater 1408, and a fan 1410 to control the climate within the canopy 1301 for a person P. The battery 1404, in some embodiments, may be used to power other electric or electronic devices, for example, a laptop computer. The battery 1404 may optionally be charged via a solar cell 1402. In an example embodiment, the battery 1404 may otherwise be plugged into an electrical outlet via a transformer (not shown) which recharges the battery 1404. In an example embodiment, the solar cell is made of flexible material and is part of outer surface of the canopy 1301.

Referring back to FIG. 13, the first canopy portion 1301 and the second canopy portion 1305 may be separated at the hinge seam 1306 and folded back into the sides and ends of the second portion 1304 and the first portion 1302. The second portion 1304 may then be pivoted with respect to the first portion 1302 about the hinge 500 in order to fold the suitcase bed 100 180 degrees into the folded position. The second portion 104 may then be removably secured to the first portion 102. This enables the suitcase bed 100 to be transported by pulling or carrying as was described above.

Although the above description makes reference to a foldable bed which unfolds from a suitcase, it is to be understood that the foldable bed could form other items of luggage, for example, a trunk.

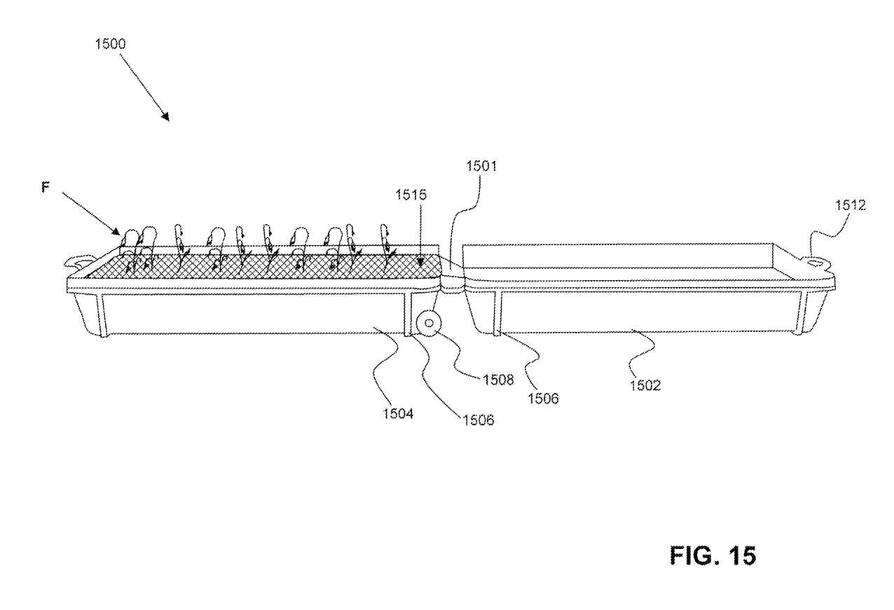

Turning now to FIG. 15, a folding potting bed 1500 is provided. Similar to the suitcase bed 100, the folding potting bed 1500 comprises a frame 1506, a second portion 1502, a first portion 1504, and a hinge 1501. In an example embodiment, the frame 1506 further comprises a handle 1512 and a pair of wheels 1508. The second portion 1502 is pivotal about the hinge 1501 with respect to the first portion 1504. For example, in an embodiment, the second portion 1502 is pivotal about the hinge 1501 to an angle of about 180 degrees. In an example embodiment, the folding potting bed 1500 further comprises a screen 1515 which can retain soil in the first portion 1504 while the potting bed 1500 is being moved or being held at an angle with respect to gravity. The soil within the first portion 1504 and, in some embodiments, within the second portion 1502, forms a flower bed or a plant bed, with the exposed surface of the soil defining the bedding surface. It will be understood that components of the folding potting bed 1500 may be formed of the same materials as the suitcase bed 100. The components of the folding potting bed 1500 may otherwise be made of different materials, for example, the folding potting bed 1500 may comprise one or more biodegradable materials.

The folding potting bed 1500 may be used as a movable or transportable potting bed. For example, a user may deposit soil in the first portion 1504 of the folding potting bed 1500 and plant flowers F, or other types of plants, in the soil. In an example embodiment, the first portion 1504 comprises perforations on its under-surface to enable roots of the plants P to penetrate into the ground below. In various example embodiments, the second portion 1502 and/or the first portion 1504 may be formed from the same materials as the suitcase bed 100 or be composed of a different material, for example, a biodegradable material. The flowers F may be planted in both the second portion 1502 and the first portion 1504, however, the flowers F may be planted in only one portion of the flower bed 1500 to enable the other portion to be used as a lid.

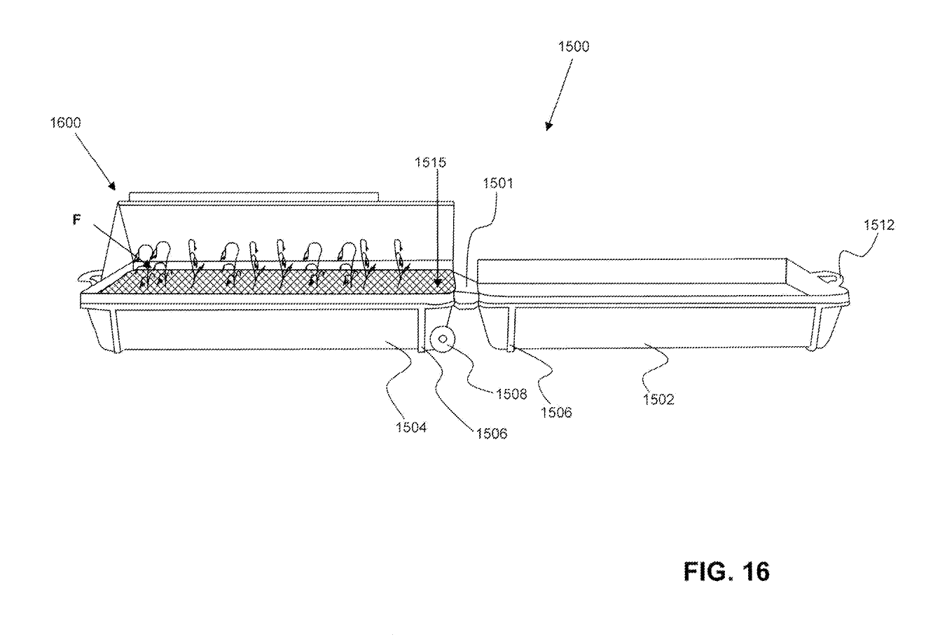

In the example embodiment of FIG. 16, the potting bed 1500 further comprises a canopy 1600 which may be deployed to cover the flowers F within the potting bed 1500. The canopy 1600 of the potting bed 1500 may be used to protect the flowers F from adverse climate. For example, in some embodiments, the canopy 1600 is transparent to enable light to pass through the canopy material and providing a chamber within which a greenhouse effect may occur.

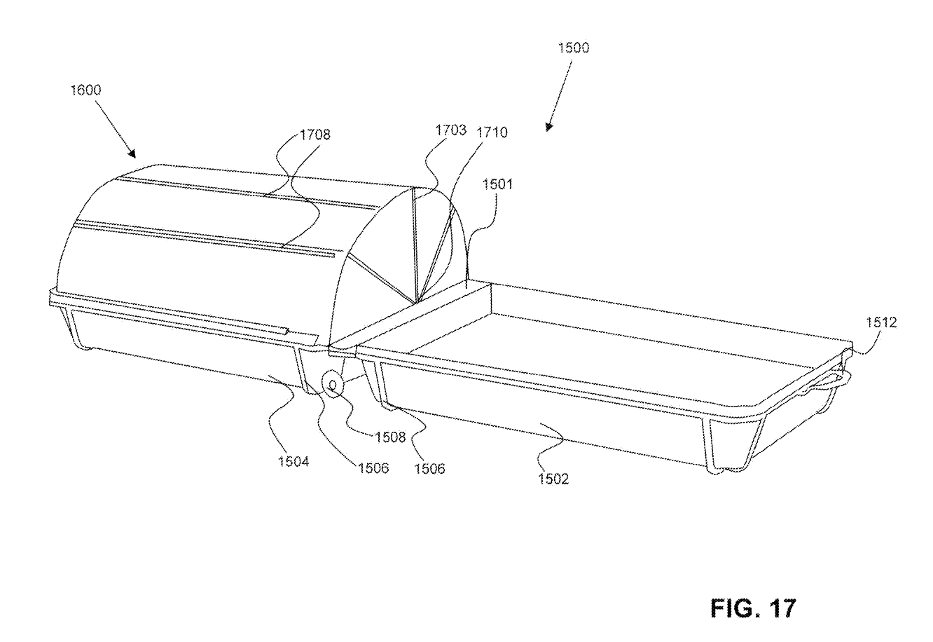

Turning to the example embodiment of FIG. 17, it can be seen that the construction of the canopy 1600 is substantially similar to the construction of the canopy 1302 for the suitcase bed 100. In this example embodiment, the canopy 1600 comprises a plurality of end supports 1703 which are connected to longitudinal supports 1708. The end supports 1703 are rotatably coupled to a pivot 1710 at each end of the canopy 1600. The edge of the canopy 1600 may be gripped and moved in an approximately arcuate path about the axis of the pivots 1710 to open and close the canopy 1600.

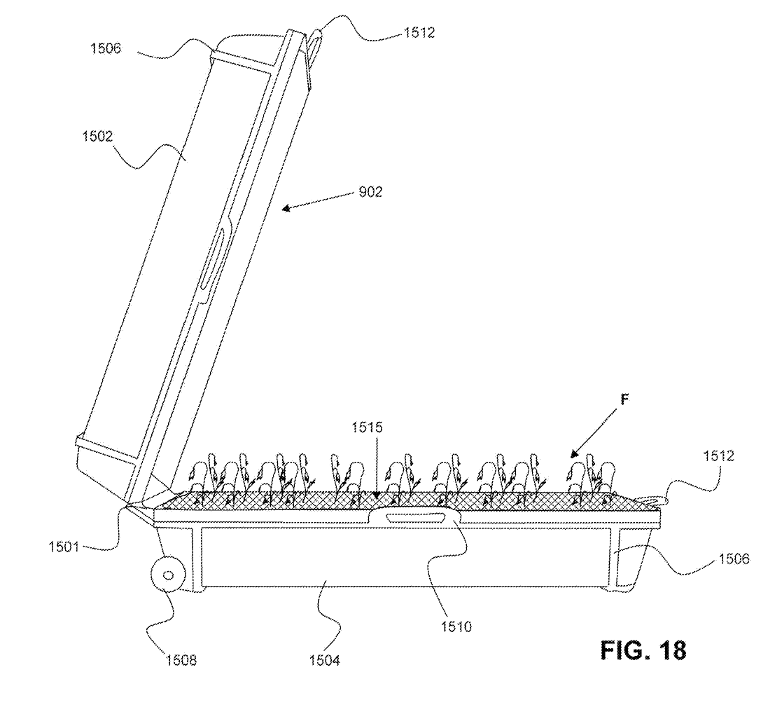

FIG. 18 shows the second portion 1502 of the folding potting bed 1500 pivoted about the hinge 1501. Various types of hinges can be used. As described above, the second portion 1502 may be used as a lid. In an example embodiment, a fastener may releasably secure the second portion 1502 to the first portion 1504. The fastener may comprise, for example, hook and loop fastener, a zipper, etc. A user may then lift the folding potting bed 1500 by the handle 1512 and transport the potting bed 1500 by rolling the potting bed 1500 on the pair of wheels 1508. The screen 1515, if present, helps to retain the soil within the potting bed 1500 if the potting bed 1500 is inclined. In some example embodiments, the second portion 1502 is transparent to provide the chamber defined by the second portion 1502 a greenhouse effect when the second portion 1502 is secured to the first portion 1504.

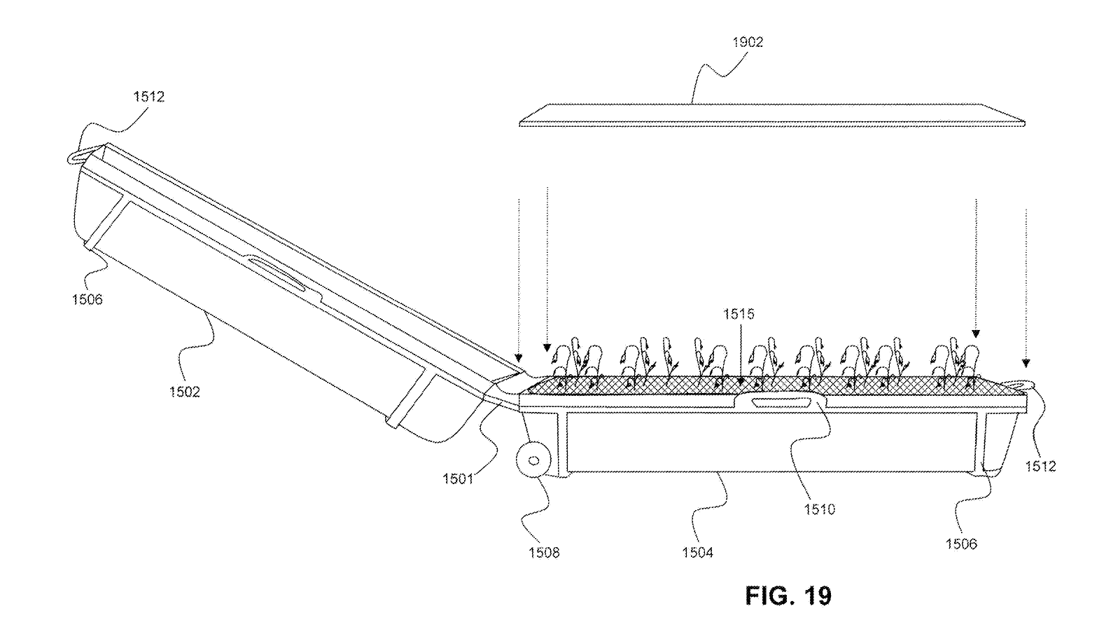

In an example embodiment, the folding potting bed 1500 comprises a lid 1902 which is removably positioned over the first portion 1504, as can be seen in FIG. 19. The lid 1902 is placed over the plantbed during transportation of the suitcase to prevent soil from shifting. The lid 1902 is optionally removably affixed to the first portion 1504 or the second portion 1502. In an example embodiment, the lid 1902 is transparent to enable light to impinge on the plants growing beneath the lid 1902. In an example embodiment, the lid is perforate. In an example embodiment, the lid is insulating. In the example embodiment of FIG. 19, the lid is rectangular, however, it can be appreciated that the lid 1902 could be another geometry, for example, a dome. The lid, for example, is also considered to be a screen to retain the soil.

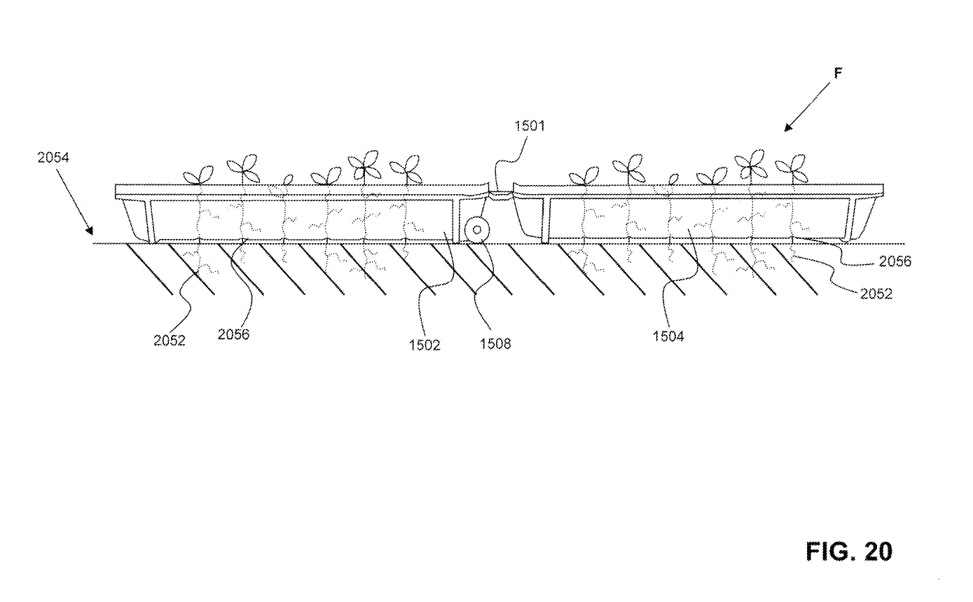

Referring now to FIG. 20, an example embodiment of the folding potting bed 1500 is shown. The first portion 1504 and the second portion 1502 both comprise soil within which plants or flowers F are potted. In an example embodiment, the first portion 1504 and the second portion 1502 comprise perforations 2056, enabling the roots 2052 of the plants to penetrate soil upon which the folding potting bed 1500 rests. Enabling the roots 2052 to penetrate the soil 2054 upon which the potting bed 1500 rests enables the folding potting bed 1500 to accommodate plants with larger root systems while holding less soil. It can be appreciated that lids 1902 may be placed over the first portion 1502 and the second portion 1504 of the potting bed 1500.

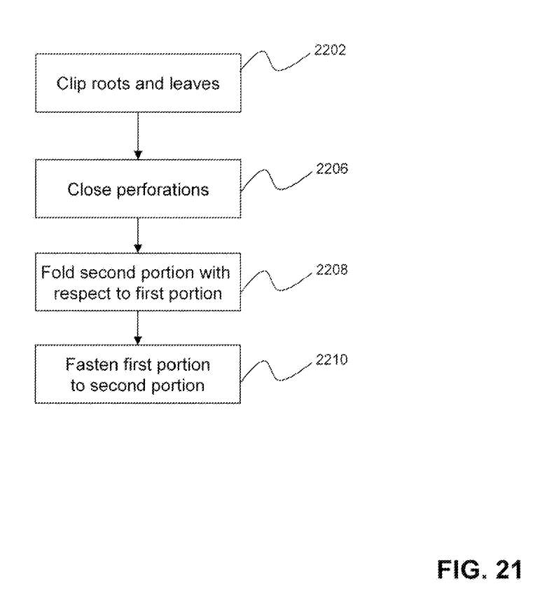

It may be desirable to transport the folding potting bed 1500 comprising the plants after the roots 2052 have penetrated the soil 2054 through the perforations 2056. Referring to FIG. 21, an example embodiment of a process for folding the potting bed 1500 is provided. In step 2202, the roots and leaves of the plants are clipped, leaving the potting bed without any plant material extending substantially out of the soil in the first portion or the second portion of the potting bed 1500. After the leaves or tops of the vegetation are clipped, a lid 1902 is placed on top of the soil. One or two lids may be used, for example, depending if soil is placed in both portions 1502, 1504.

In some embodiments, once the roots 2052 are clipped from the perforations, the perforations may be closed by a perforation closing mechanism (step 2206). The second portion 1502 may be folded with respect to the first portion 1504 about the hinge 1501 in step 2208. In some embodiments, the second portion 1502 is folded approximately 180 degrees with respect to the first portion 1504. In step 2210, the first portion 1504 is fastened to the second portion 1502 using a fastener. In some embodiments, the fastener may be the same fastener as is used in the suitcase bed 100, for example, a latch, a zipper, a belt, etc.

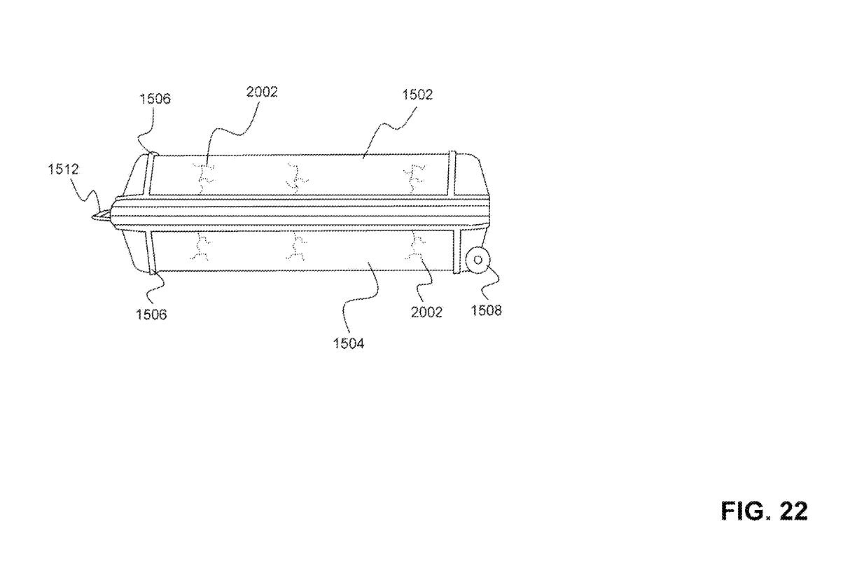

Referring now to FIG. 22, the folding potting bed 1500 of FIG. 20 is shown folded and latched, according to the process outlined in FIG. 21. As it can be appreciated, the folding potting bed 1500 may then be transported similarly to a conventional suitcase. For example, a user may hold the handle 1512 and pull the folding potting bed 1500 on the pair of wheels 1508. This enables the folding potting bed 1500 to be transportable or movable.

Upon reaching the desired destination, the first portion 1504 of the folding potting bed 1500 may be unfastened and folded with respect to the second portion 1502 of the folding potting bed. In some embodiments, the folding potting bed 1500 is unfolded and placed on soil 2054 and the perforations 2056 are opened to enable the roots 2052 of the plants to grow into the soil 2054.

It can be appreciated that a power system similar to that disclosed in FIG. 14 may be provided to regulate the environment within the folding potting bed 1500. An example power system comprises a solar cell, a heater, a fan, and a light source.

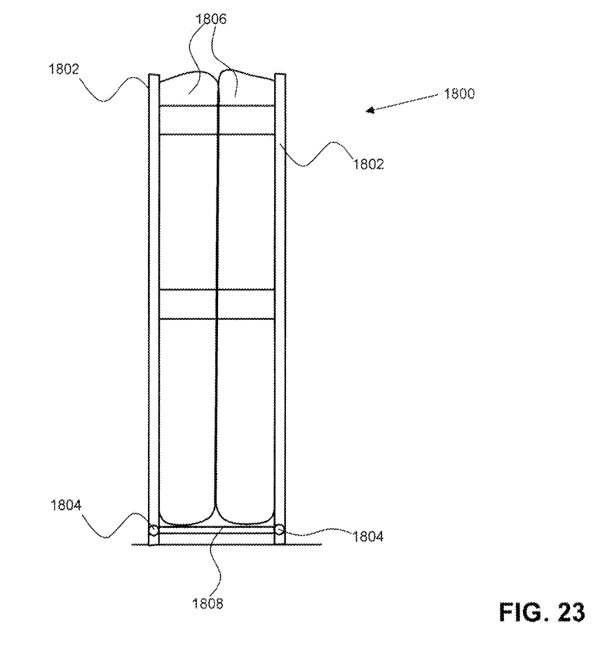

Turning now to FIG. 23, a collapsible bed 1800 comprising a folding chair is provided. The collapsible bed 1800 comprises a pair of supports 1802, each joined to a centrepiece 1808 via hinges 1806. The supports 1802 are pivotal with respect to the centrepiece 1808 about the hinges 1806. The collapsible bed 1800 further comprises a pair of mattress elements 1806 located between the supports 1802. Pivotally secured to each support is a pair of legs (not shown) which extend vertically to hold the supports 1802 when the collapsible bed 1800 is unfolded.

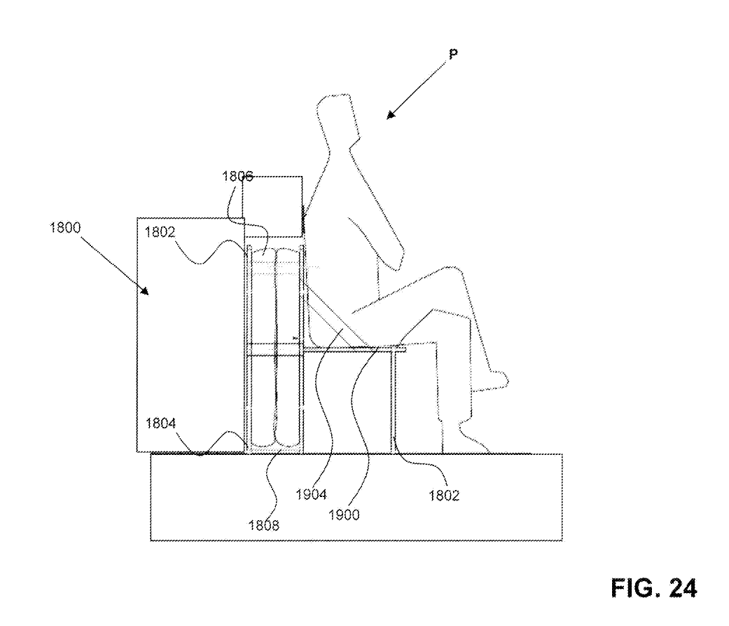

In one embodiment, the collapsible bed 1800 may have a folding seating portion that forms a seat. In an example embodiment shown in FIG. 24, the collapsible bed is attached to a seat portion 1900 which is secured to one support 1802 and reinforced by a belt 1904, for example, a nylon belt, when a person P is using the chair. The seat portion 1900 further comprises a vertical leg 1902 which supports the seat portion 1900.

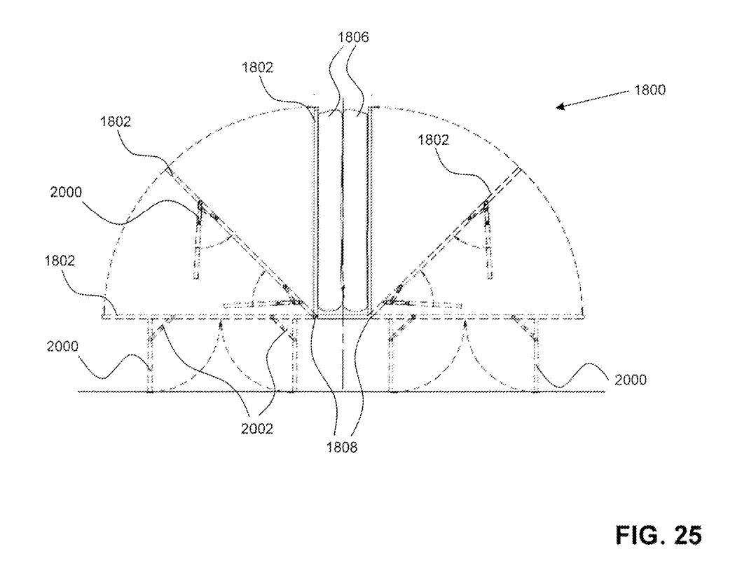

Turning now to FIG. 25, the collapsible bed 1800 may be unfolded by pivoting each of the supports 1802 about the hinges 1808 to an angle of about ninety degrees. The legs 2000 pivotally unfold under the supports to life the collapsible bed 1800 off the surface upon which it rests.

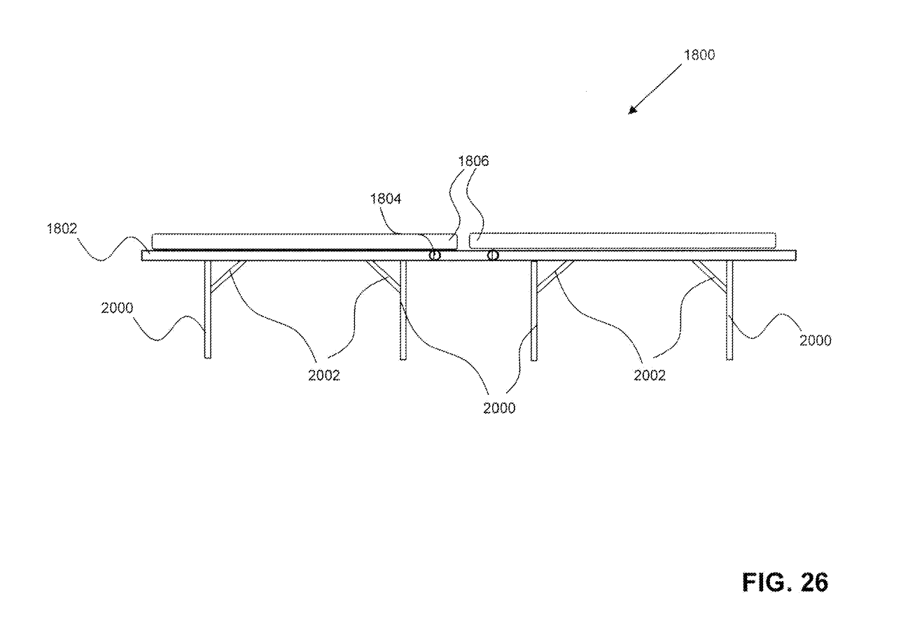

FIG. 26 shows the collapsible bed in the unfolded position. The supports 1802 are approximately horizontal, enabling a person P to rest on the bed. The legs 2000 retain the supports 1802 off the surface upon which they rest. The mattresses 1806 may receive a person who is in the laying position. The legs 2000 may further be retained in their vertical position by corner joists 2002, which prevent the legs from folding when the collapsible bed is unfolded. The user may remove or collapse the joists, fold the legs and pivot the supports ninety degrees away from the legs to collapse the collapsible bed 1802.

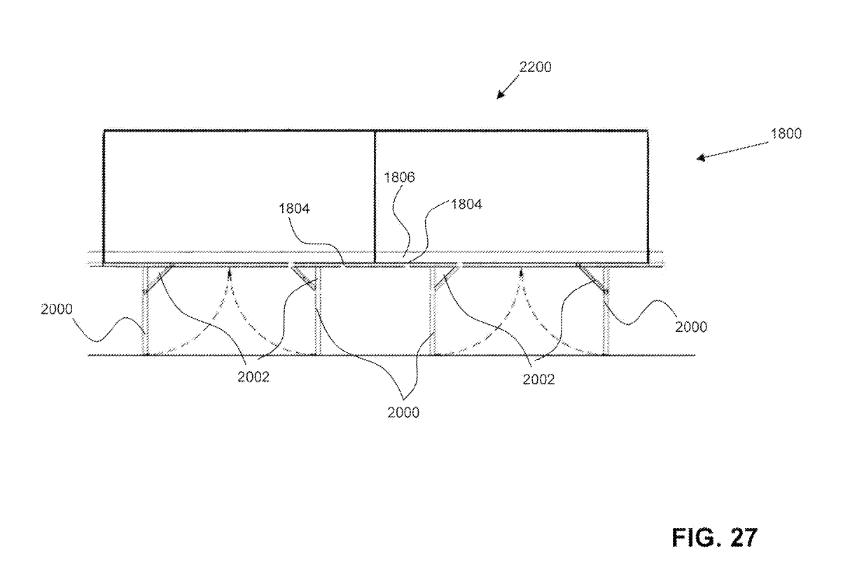

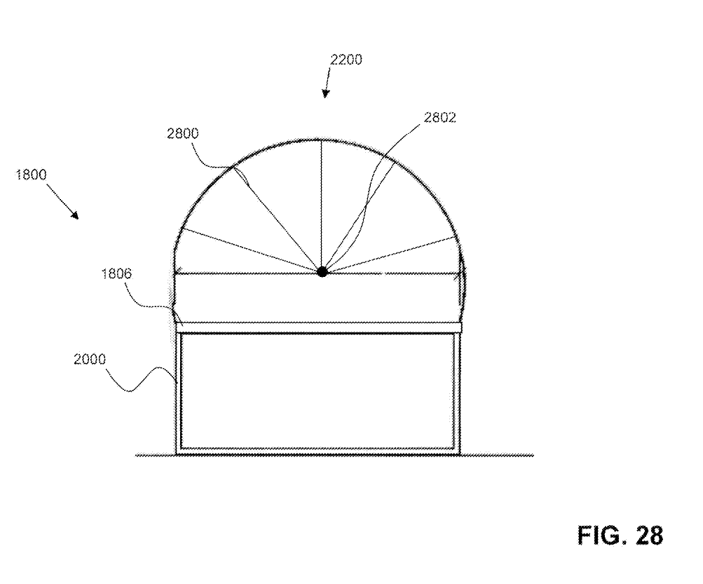

Referring to the example embodiment of FIG. 27, the collapsible bed 1800 further comprises a canopy 2200 which may cover a person resting on the collapsible bed. The canopy 2200 may be of a structure that is substantially similar to the canopy 1301 of the foldable bed 100 and the flower bed 1300, comprising longitudinal supports (not shown), and as can be seen in FIG. 28, end supports 2800 which extend from a pivot 2802.

In a general example embodiment, a suitcase configured to transform to a bed is provided. It includes a frame with a hinge. The frame is secured to a first portion and a second portion. The second portion is pivotally connected to a first portion about the hinge. The first portion and the second portion respectively include a first inner face and a second inner face. The first inner face includes a first mattress and the second inner face includes a second mattress. At least one of the first portion and the second portion include a fastener to releasably secure the second portion to the first portion. When the first portion and the second portion are in an open configuration, the first mattress and the second mattress form the bed.

In an example embodiment aspect, when the first portion and the second portion are in a closed configuration, the first portion is fastenable to the second portion to form the suitcase. In another example embodiment aspect, the first portion includes an outward facing cover for accessing a first storage compartment. In another example embodiment aspect, the second portion includes an outward facing cover that defines a second storage compartment. In another example embodiment aspect, the suitcase further includes a canopy. In another example embodiment aspect, the canopy is a collapsible canopy including a material which is spread over longitudinal supports and end supports, the end supports extending from a pivot at an end of the suitcase. In another example embodiment aspect, the canopy includes one or more solar cells. In another example embodiment aspect, a handle for the suitcase is provided.

In a general example embodiment, a suitcase configured to transform to a potting bed is provided. It includes a frame with a hinge. The frame is secured to a first portion and a second portion of the suitcase. The second portion is pivotally connected to the first portion about the hinge. At least one of the first portion and the second portion includes a soil container. At least one of the first portion and the second portion includes a fastener to releasably secure the second portion to the first portion. When the first portion and the second portion are in an open configuration, the soil container forms the potting bed.

In an example embodiment aspect, both the first portion and the second portion each include the soil container that form the potting bed when the first portion and the second portion are in the open configuration. In another example embodiment aspect, when the first portion and the second portion are in a closed configuration, the first portion is fastenable to the second portion to form the suitcase. In another example embodiment aspect, the suitcase includes a canopy. In another example embodiment aspect, the canopy is a collapsible canopy including a material which is spread over longitudinal supports and end supports, the end supports extending from a pivot at an end of the suitcase. In another example embodiment aspect, the suitcase includes a screen to retain the soil within the soil-retaining chamber when the first portion is inclined or in motion. In another example embodiment aspect, the second portion is transparent or translucent. In another example embodiment aspect, the soil container is perforate. In another example embodiment aspect, the first portion further includes a pair of ground-engaging wheels.

In a general example embodiment, a collapsible bed is provided. It includes a pair of supports, each joined to a centrepiece about a hinge. Each of the supports are pivotally mounted with respect to the centrepiece about the hinge. A pair of mattress elements are located between the supports. The collapsible bed also includes a pair of foldable support-retaining legs, which deploy when the collapsible bed is unfolded.

In an example embodiment aspect, it further includes a collapsible canopy comprising a material which is spread over longitudinal supports and end supports, the end supports extending from a pivot at an end of the collapsible bed.

Although the above has been described with reference to certain specific example embodiments, various modifications thereof will be apparent to those skilled in the art without departing from the scope of the claims appended hereto.

1. A suitcase configured to transform to a bed comprising:
a frame comprising a hinge, the frame being secured to a first portion and a second portion; and
the second portion being pivotally connected to a first portion about the hinge;
the first portion and the second portion respectively comprising a first inner face and a second inner face, the first inner face comprising a first mattress and the second inner face comprising a second mattress;
at least one of the first portion and the second portion comprising a fastener to releasably secure the second portion to the first portion; and
wherein when the first portion and the second portion are in an open configuration, the first mattress and the second mattress form the bed.

2. The suitcase of claim 1 wherein when the first portion and the second portion are in a closed configuration, the first portion is fastenable to the second portion to form the suitcase.

3. The suitcase of claim 1 wherein the first portion comprises an outward facing cover for accessing a first storage compartment.

4. The suitcase of claim 1 wherein the second portion comprises an outward facing cover that defines a second storage compartment.

5. The suitcase of claim 1 further comprising a canopy.

6. The suitcase of claim 5 wherein the canopy is a collapsible canopy comprising a material which is spread over longitudinal supports and end supports, the end supports extending from a pivot at an end of the suitcase.

7. The suitcase of claim 6 wherein the canopy comprises one or more solar cells.

8. The suitcase of claim 1 comprising a handle.

9. The suitcase of claim 1 wherein the hinge is a piano hinge.

10. A suitcase configured to transform to a potting bed comprising:
a frame comprising a hinge, the frame being secured to a first portion and a second portion; and
the second portion being pivotally connected to the first portion about the hinge; at least one of the first portion and the second portion comprising a soil container;
at least one of the first portion and the second portion comprising a fastener to releasably secure the second portion to the first portion; and
wherein when the first portion and the second portion are in an open configuration, the soil container forms the potting bed.

11. The suitcase of claim 10 wherein both the first portion and the second portion each comprise the soil container that form the potting bed when the first portion and the second portion are in the open configuration.

12. The suitcase of claim 10 wherein when the first portion and the second portion are in a closed configuration, the first portion is fastenable to the second portion to form the suitcase.

13. The suitcase of claim 10 further comprising a canopy.

14. The suitcase of claim 13 wherein the canopy is a collapsible canopy comprising a material which is spread over longitudinal supports and end supports, the end supports extending from a pivot at an end of the suitcase.

15. The suitcase of claim 10 further comprising a screen to retain the soil within the soil-retaining chamber when the first portion is inclined or in motion.

16. The suitcase of claim 10 wherein the second portion is transparent or translucent.

17. The suitcase of claim 10 wherein the soil container is perforate.

18. The suitcase of claim 10 wherein the first portion further comprises a pair of ground-engaging wheels.

19. A collapsible bed comprising:
a pair of supports, each joined to a centrepiece about a hinge;
each of the supports being pivotally mounted with respect to the centrepiece about the hinge;
a pair of mattress elements located between the supports; and
a pair of foldable support-retaining legs which deploy when the collapsible bed is unfolded.

20. The collapsible bed of claim 19 further comprising a collapsible canopy comprising a material which is spread over longitudinal supports and end supports, the end supports extending from a pivot at an end of the collapsible bed.
